(19) United States
(12) Patent Application Publication
(10) Pub. No.: US 2009/0019171 A1
(43) Pub. Date: Jan. 15, 2009

(54) METHOD, DEVICE AND SYSTEM FOR DETERMINING MAIL CLASS

(76) Inventors: Jing Liu, Shenzhen (CN); Qiao Liu, Shenzhen (CN); Zhiguang Qin, Shenzhen (CN); Zhibin Zheng, Shenzhen (CN)

Correspondence Address: BRINKS HOFER GILSON & LIONE, P.O. BOX 10395, CHICAGO, IL, 60610, US

(21) Appl. No.: 12/169,864

(22) Filed: Jul. 9, 2008

(30) Foreign Application Priority Data
Jul. 9, 2007 (CN) 200710128086.6
Mar. 6, 2008 (CN) PCT/CN2008/070427

(51) Int. Cl. G06F 15/16

(52) U.S. Cl. 709/229

(57) ABSTRACT

The present invention discloses a method, device and system for determining a mail class. The method for determining a mail class includes: reading a mail head of a mail with an unknown class; extracting a first field in compliance with a first preset condition from the mail head; vectorizing combinations of the first field and its presentation forms into a first preset number of first feature vectors; taking the first feature vectors as input to a preset predictive algorithm for calculation with use of data stored for a pre-established behavior model to derive a calculation result; and determining the mail class of the mail with an unknown class from the calculation result.

This application claims the priority of Chinese Patent Application No. 200710128086.6, entitled “METHOD, DEVICE AND SYSTEM FOR DETERMINING MAIL CLASS AND DEVICE FOR ESTABLISHING BEHAVIOR MODEL”, and filed with the Chinese Patent Office on Jul. 9, 2007, and the priority of International patent application No. PCT/CN2008/070427, entitled “METHOD, DEVICE AND SYSTEM FOR DETERMINING MAIL CLASS”, and filed on Mar. 6, 2008, which are hereby incorporated by reference in its entirety.

### FIELD

The present embodiments relate to Internet technologies and in particular to determining a mail class.

### BACKGROUND

E-mails over the Internet have been popular with net users as a predominant application. Junk mail has become increasingly serious in recent years. Junk mail is generally unsolicited and for business or other advertisement purposes. Determination of a junk mail is closely related to a receiver of the mail, and different users may have different results of determining the same mail. With the development of technology, filtering junk mail is in transition from technologies simply based upon static rules and statistic classification to technologies based upon behavior.

Current primary methods for filtering junk mails are typically based upon the content of a mail. A method for filtering junk mail is based upon Learning Vector Quantization (LVQ). The LVQ is an iterative learning algorithm for performing a “reward/punishment” according to the feature of a sample pattern. The main idea of the LVQ is as follows. Firstly, a training set is set. Data of the training set results from partially vectorization of the mail body of a mail with a known class. For a vector from the training set, if the vector belongs to the same class as the closest neuron, learning is not performed. The vector from the training set is used as an input to the LVQ algorithm for calculation. If a calculation result complies with a preset requirement, the result indicates that the vector belongs to the same class as the closest neuron, and parameters of the algorithm will not be modified. Otherwise, if the calculation result does not comply with the preset requirement, neurons classified incorrectly will be punished and neurons classified correctly will be rewarded. If the calculation result does not comply with the preset requirement, the parameters of the algorithm will be modified. A neural network consists of a plurality of neurons. For a neuron with a correct calculation result, it is rewarded, and an iterative formula corresponding to the reward is used for iteration. A neuron with an incorrect calculation result may be punished, and an iterative formula corresponding to the punishment is used for iteration. After a number of iterations, if the resulting set of vectors does not drastically change, for example, all of the calculation results comply with the preset requirement, the set indicates that the training of the training set is accomplished.

When a mail is being filtered, the content of the mail is divided into words, and the frequency of occurrence of each word is calculated. The frequency of occurrence of each word is used as an input value to the LVQ algorithm for calculation with use of the parameters resulting from the training. If the value resulting from the calculation is determined to approximate to 1, the mail is a junk mail. Inversely, if the value is determined to approximate to 0, the mail is not a junk mail, thereby accomplishing the filtering of a junk mail.

Mail body with a large amount of contents, which vary greatly may cause slow training, or an incomplete training set, may result in a low mail filtering accuracy. Contents and formats of mail bodies may be undetermined, which may result in slow determination of a junk mail. Furthermore, the mail body of a non-Chinese mail may be represented with a zero vector, and the mail may be determined as a normal mail. Therefore, a junk mail being represented with a zero vector may not be filtered out, which may further degrade a filtering correction ratio.

### SUMMARY

The present embodiments may obviate one or more of the drawbacks or limitations inherent in the related art. For example, one embodiment may determine a mail class, which can accelerate determination of the mail class of a mail.

In a first aspect, a method for determining a mail class includes reading a mail head of a mail with an unknown class; extracting a first field in compliance with a first preset condition from the mail head; vectorizing combinations of the first field and its presentation forms into a first preset number of first feature vectors; taking the first feature vectors as input to a preset predictive algorithm for calculation with use of data stored for a pre-established behavior model to derive a calculation result; and determining the mail class of the mail with an unknown class from the calculation result.

In a second aspect, a device for determining a mail class is provided. The device includes a mail head reading unit adapted to read a mail head of a mail with an unknown class; a first field extracting unit adapted to extract a first field in compliance with a first preset condition from the mail head; a first vectorizing unit adapted to vectorize the first field into a first preset number of first feature vectors; a calculating unit adapted to take the first feature vectors as input to a preset predictive algorithm for calculation with use of data stored for a pre-established behavior model to derive a calculation result; and a determining unit adapted to determine the mail class of the mail with an unknown class from the calculation result.

In a third aspect, a system for determining a mail class is provided. The system includes a behavior model establishing unit adapted to establish a behavior model for determination of a mail class by a preset learning algorithm in a way that a mail head of a mail with a known class is read, a field in compliance with a preset condition is extracted from the mail head of the mail with a known class, and the field is vectorized into a preset number of feature vectors; and a mail class determining unit adapted to read a mail head of a mail with an unknown class, to extract a field in compliance with the preset condition from the mail head of the mail with an unknown class, to vectorize the field into the preset number of feature vectors, to take the feature vectors as input to a preset predictive algorithm for calculation with use of data stored for the behavior model to derive a calculation result, and to determine the mail class from the calculation result.

### BRIEF DESCRIPTION OF THE DRAWINGS

FIG. 1 illustrates one embodiment of a device for establishing a behavior model;

FIG. 2 illustrates one embodiment of a method for determining a mail class;

FIG. 3 illustrates another embodiment of a method for determining a mail class;

FIG. 4 illustrates one embodiment of a device for determining a mail class;

FIG. 5 illustrates a second embodiment of a device for determining a mail class; and

FIG. 6 illustrates one embodiment of a system for determining a mail class.

### DETAILED DESCRIPTION

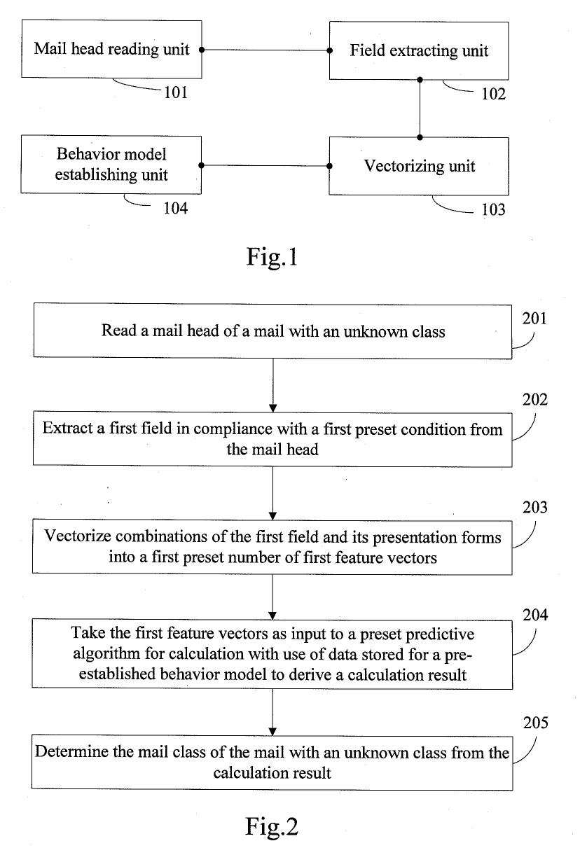

FIG. 1 illustrates a device for establishing a behavior model. The device for establishing a behavior model includes a mail head reading unit 101, a field extracting unit 102, a vectorizing unit 103, and a behavior model establishing unit 104.

The mail head reading unit 101 is adapted (operable) to read a mail head of a mail with a known class.

A mail head refers to signaling transferred between mail servers using the Simple Message Transfer Protocol (SMTP). The contents of the mail head are invisible to a composer and a receiver of the mail. The contents of a part of the mail head may be formatted and some fields may be preset as prescribed in the SMTP protocol. Accordingly, normal transfer of the mail may be ensured. A mail with a known class refers to the class of the mail that is known (it may be determined whether the mail is a normal or junk mail).

The field extracting unit 102 is adapted (operable) to extract from the mail head a field in compliance with a preset condition.

Mail heads may be in compliance with requirements as prescribed in the SMTP protocol. Accordingly, some fields are common in the mail head of each of the mails. In terms of the SMTP protocol, the following fields in a mail head are vulnerable to falsification: the From field, the To field, the Reply-To field, the Delivered-To field, the Return-Path field, the Received field, and the Date field. For example, the From field includes the mail address of a sender, the To field includes the mail address of a receiver, the Reply-To field includes a reply-to mail address (i.e. a mail address to which the receiver replies), and the Return-Path field includes the mail address of a final sender added by the last server in the course of forwarding of the mail. Since these fields are vulnerable to falsification, part or all of the fields may be selected using the preset condition during classification of the mails.

The vectorizing unit 103 is adapted (operable) to vectorize the fields into a preset number of feature vectors.

After the fields in compliance with the preset condition are extracted, the fields are combined into several combinations depending upon each of the different fields. For example, if some fields of a mail satisfy a combination, the combination takes a value of 1. Otherwise, if any fields of a mail do not satisfy a combination, the combination takes a value of 0. A series of values obtained for the mail is the value of a feature vector. The calculation process is a vectorization process.

For example, the above fields in a mail head each may be presented in the following forms: 1) the field is absent; 2) the field is present but null; 3) the mail address of the sender includes a null username, such as @zhangsan.com; 4) the mail address of the sender includes a null domain name; 5) the mail address of the sender is in an incorrect format, such as presence of an illegal character like “*”; 6) no Domain Name Server (DNS) record can be found in accordance with the domain name of the mail address; 7) the mail address of the sender contains two symbols of @; 8) the mail address of the sender includes no symbol of @; 9) the mail address of the sender includes only a symbol of @ but neither user name nor domain name; 10) the data value in the Date is obsolete; and 11) the number of the Received is excessively large(e.g., an excessive number of routes have been passed).

Thus, the eleven scenarios in combination with the seven fields may give rise to seventy-seven features, so that these fields may be vectorized into seventy-seven feature vectors. However, in practical applications, not all the eleven scenarios will appear for some fields. For example, the Date field may correspond only to the three scenarios of 1), 2) and 10). Furthermore, some fields if combined for determination may be more effective. Therefore, the number of features to be selected may be determined depending upon a specific implementation.

The behavior model establishing unit 104 is adapted (operable) to establish a behavior model for the feature vectors in a preset learning algorithm.

After the feature vectors into which the fields are vectorized have been obtained, these feature vectors may be combined into a set of feature vectors as an input to the preset learning algorithm for calculation. The obtained parameters may be stored in a behavior model, which is a visual file for storage of the parameters to be used for determination of a mail class. The parameters may be relevant to the preset algorithm and may be called for determination of a mail class with use of the preset predictive algorithm. The parameters may be stored in establishment of the behavior model, (e.g., obtained in a learning process using the preset learning algorithm), and may vary constantly as input data in the learning process varies constantly. The accuracy and effectiveness of the parameters may be enhanced constantly as learned samples are improved constantly and the input data becomes increasingly reasonable. The calculation accuracy of the preset predictive algorithm may be improved accordingly.

The device for establishing a behavior model may use the information of a mail head to establish a behavior model required for determination of a mail class. Since the mail head may comply with the SMTP protocol, it is possible to avoid slow training or incomplete training set in establishment of the behavior model. In determination of a mail class, the fields to be determined may be preset, and a mail class may be determined rapidly. Since the behavior model is established from the mail head, the behavior model may be useful in determination, regardless of the specific language of the mail body.

A behavior model may be established by a Support Vector Machine (SVM). The SVM is a data-based machine learning method on the basis of the statistic learning Vapnik-Chervonenkis Dimension theory and the structure risk minimum principle. The SVM seeks an optimal trade off between the complexity (i.e. the precision of learning a specific training sample) and the learning ability (i.e. the ability to identify any sample in an error-free way) of the model from information of limited samples, so as to achieve an optimal generalization ability. The SVM may be designed specially for the case of limited samples and intended to obtain an optimal solution for the existing information instead of just an optimal value in the case that the number of samples tends to be infinite. The algorithm may be translated into a problem of quadratic optimal seeking, which theoretically results in a globally optimal point and avoids the problem of a locally optimal value inevitable in a neural network method. The algorithm may translate a real problem into a high-dimension feature space by nonlinear transformation and construct a linear decision function in the high-dimension feature space for a nonlinear decision function in the original space. Such special nature may ensure good generalization ability for the machine learning method while solving smartly the problem of the number of dimensions in that the complexity of the algorithm is independent of the number of dimensions of samples. In the SVM method, a number of existing learning algorithms such as polynomial approximation, a Bayesian classifier, a Radical Basic Function (RBF), or a multi-layer sensor network, may be implemented simply by defining different inner product functions. The SVM may address a small number of samples, nonlinearity, a large number of dimensions, and a local minimum point.

In one embodiment, the seven fields described above may be adopted for establishing a behavior model through the SVM. Since the From field, the To field, the Reply-To field, the Delivered-To field and the Return-Path field are expressed in the same format, every two of the five fields may be combined, obtaining ten combinations. The ten combinations, together with the above seven fields, give rise to seventeen combinations, and several features may be extracted from those combinations further in conjunction with the eleven scenarios described above. Of course, scenarios other than the above eleven scenarios may be possible in a practical application, and an alternative number of features may be selected depending upon a specific application. For example, 106 features are extracted from continuous tests.

The above seven fields are extracted from the mail head and combined into seventeen combinations, and the mail head may be split into 106 feature vectors by combining the combinations with the eleven scenarios. The SVM learning algorithm is executed with the resulting 106 feature vectors to establish a behavior model.

FIG. 2 illustrates a method for determining a mail class. As shown in FIG. 2, a mail head of a mail with an unknown class is read (act 201). A first field in compliance with a first preset condition is extracted from the mail head (act 202). The first field may be, but is not limited to, any combination of the From field, the To field, the Reply-To field, the Delivered-To field, the Return-Path field, the Received field and the Date field. In order to identify accurately the mail class of the mail with an unknown class, the first condition may be set for the extracted first field, (e.g., making it to be the same as the field extracted in establishment of the behavior model).

Combinations of the first field and its presentation forms are vectorized into a first preset number of first feature vectors (act 203). The vectorization process may be the same as in establishment of the behavior model, and the number of the resulting feature vectors is the same as in establishment of the behavior model, thereby enabling conformity with the behavior model and ensuring the accuracy of the determination.

The first feature vectors are input to the preset predictive algorithm for calculation with use of data stored for the pre-established behavior model to derive a calculation result (act 204). After the feature vectors resulting from vectorization of the mail head have been obtained, the feature vectors are combined into a set of feature vectors, which are input to the preset predictive algorithm for calculation to derive a calculation result, where the parameters in the behavior model are used as parameters for the predictive algorithm. Since the behavior model is derived from a constant training and the parameters may be optimized constantly along with the training, the use of these parameters may result in correct calculation. Values of the feature vectors in the set of feature vectors optimized in the behavior model are engaged in calculation of the predictive algorithm, so that the calculation result may be made more accurate.

The preset predictive algorithm may correspond to the learning algorithm used in establishment of the behavior model. For example, if the SVM learning algorithm is used in establishment of the behavior model, the predictive algorithm may adopt an SVM predictive algorithm. If the Radical Basic Function (RBF) learning algorithm is used in establishment of the behavior model, the predictive algorithm may adopt an RBF predictive algorithm accordingly. In one application, the learning algorithm and the predictive algorithm may not correspond to each other. For example, if the SVM learning algorithm is used in establishment of the behavior model, a predictive algorithm can be used in determination if that predictive algorithm offers a better calculation effect than the SVM predictive algorithm in a practical application.

Taking it as an example that mails are only classified into two classes (e.g., junk mails and non-junk mails), a general calculation process of the SVM predictive algorithm is as follows. In view of the only two classes, the data may be classified into two classes labeled with 0 and 1, and a model is derived by training for the two classes. In a prediction, test samples each are predicted using all the models resulting from the training, and the class to which the test sample belongs may be determined from a predictive value of 0 or 1.

The process may be expressed with the following mathematic problem.

The object is to find a hyperplane as a classification plane where the two classes of data points can be separated correctly as many as possible while the separated two classes of data points are the farthest from the classification plane. An equation of the plane is assumed as y=wx+b, and the object is primarily to solve w and b.

The solving method is to construct a restricted optimization problem, particularly a restricted quadratic planning problem, which is solved to derive a classifier.

In establishment of a model, a sub-module firstly vectorizes mails in a training set and then establishes a model based upon the idea of the Support Vector Machine, particularly a C-Support Vector Machine (C-SVC) classifier, a dual function of which is used to calculate the following major parameters.

$${r}_{1} = \frac{{\sum }_{0 < α < C , yi = 1} ∇ {f ( α )}_{i}}{{\sum }_{0 < α < C , yi = 1} 1}$$

$$ρ = \frac{{r}_{1} + {r}_{2}}{2}$$

Finally, a decision function of the classifier is obtained, and the major parameters and decision information are stored into a model file for later calling by a determination module, where the model file includes the following contents.

The major parameters are the parameters in the behavior model, and the decision information refers to values of modified feature vectors of the mail.

The prediction process is as follows.

The mail to be processed is vectorized, and then the above two parts of contents in the model file are read and induced into the decision function of:

$$f ( x ) = sgn ( {\sum }_{i = 0}^{l} {α}_{i} {y}_{i} K ( x , {x}_{i} ) + b )$$

$$where$$

$$K ( {x}_{i} , {x}_{j} ) = exp ( - γ {‖ {x}_{i} - {x}_{j} ‖}^{2} ) , γ > 0$$

Finally, a classification result is determined from a resulting value of f(x).

The mail class of the mail with an unknown class is determined from the calculation result (act 205).

A value may be derived from calculation of the predictive algorithm, and the class of the mail may be determined from the prescription for vectorization of the mail head in presetting the behavior model. For example, if a normal mail takes a value of 1 in establishment of the behavior model, the mail with an unknown class is determined as a normal mail when the calculation result is 1. Otherwise, the mail with an unknown class is determined as a junk mail when the calculation result is 0. Other integer values may be selected arbitrarily to identify the classes, and may be determined primarily depending upon values adopted for a normal mail and a junk mail in establishment of the behavior model.

The mail head may be vectorized. The predictive algorithm corresponding to the learning algorithm used in establishment of the behavior model together with data stored for the behavior model pre-established from the training to derive a calculation result from which the mail class is determined may be adopted. Since the mail head may comply with the SMTP protocol, therefore in determination of the mail class, the fields to be determined all have been preset, thereby resulting in rapid determination of the mail class. Since the behavior model is established from the mail head, the behavior model may be useful in determination regardless of a specific language of the mail body.

In another embodiment, a method for determining a mail class may be provided. After a mail has been received, corresponding seven fields are extracted from a mail head of the mail and vectorized into 106 feature vectors. The vectors are input to the SVM predictive algorithm for calculation with use of data stored for a pre-established behavior model. A calculation result is determined in a way that, for example, if the result is 1, it indicates that the mail is a normal mail, otherwise the mail is a junk mail.

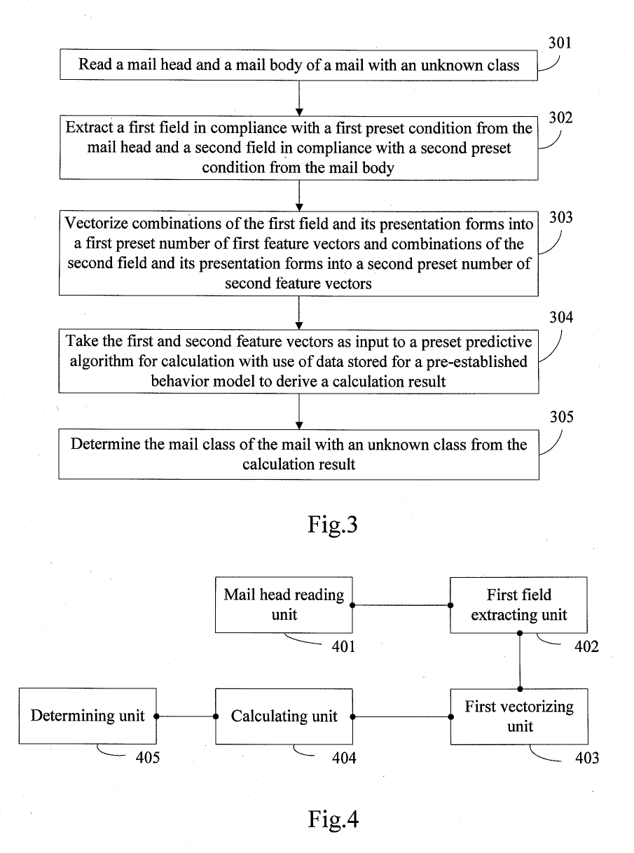

FIG. 3 illustrates yet another embodiment of a method for determining a mail class. A mail head and a mail body of a mail with an unknown class are read (act 301). A first field in compliance with a first preset condition is extracted from the mail head, and a second field in compliance with a second preset condition is extracted from the mail body (act 302). Operations for the mail body are similar to those for the mail head except that the field for the mail body is selected by selecting a corresponding keyword from the mail body as in the prior art.

Combinations of the first field and its presentation forms are vectorized into a first preset number of first feature vectors, and combinations of the second field and its presentation forms are vectorized into a second preset number of second feature vectors (act 303). Presentation forms of a keyword may include presence of the keyword, absence of the keyword, the number of occurrence of the keyword, etc.

The first feature vectors and the second feature vectors are input to a preset predictive algorithm for calculation with use of data stored for a pre-established behavior model to derive a calculation result (act 304).

The mail class of the mail with an unknown class is determined from the calculation result (act 305). In one embodiment, the mail body of the mail with an unknown class is processed additionally, so that more accurate determination of the mail class can be made comprehensively from the contents of the mail head and the mail body.

FIG. 4 illustrates one embodiment of a device for determining a mail class. The device for determining a mail class includes a mail head reading unit 401, a first field extracting unit 402, a first vectorizing unit 403, and a calculating unit 404, a determining unit 405, or a combination thereof.

The mail head reading unit 401 is adapted (operable) to read a mail head of a mail with an unknown class. The first field extracting unit 402 is adapted to extract a first field in compliance with a first preset condition from the mail head. The first field may be, but is not limited to any one or more combination of the From field, the To field, the Reply-To field, the Delivered-To field, the Return-Path field, the Received field and the Date field, while it shall be the same as the field in establishment of a behavior model.

The first vectorizing unit 403 is adapted to vectorize the first field into a first preset number of first feature vectors. The vectorization process may be the same as in establishment of the behavior model, and the number of the resulting feature vectors is also the same as in establishment of the behavior model.

The calculating unit 404 is adapted to take the first feature vectors as input to a preset predictive algorithm for calculation with use of data stored for the pre-established behavior model to derive a calculation result. Relevant information of the preset predicative algorithm is determined depending upon a learning algorithm used in establishment of the behavior model and is stored in the behavior model. After the vectors resulting from vectorization of the mail head are obtained, these vectors are input to the preset predictive algorithm for calculation with use of data stored for the pre-established behavior model to derive a calculation result.

The determining unit 405 is adapted to determine the mail class of the mail with an unknown class from the calculation result of the calculating unit 404.

A value of typically 1 or 0 can be derived from calculation of the predictive algorithm. Depending upon different parameters in the behavior model, the mail is determined as a normal mail when the calculation result is 1, while the mail is determined as a junk mail when the calculation result is 0. The value will not be limited to 1 or 0 in a practical application and may be determined particularly depending upon values adopted for a normal mail and a junk mail in establishment of the behavior model.

In one embodiment, the mail head may be vectorized. The predictive algorithm corresponding to the learning algorithm used in establishment of the behavior model together with data stored for the behavior model pre-established from the training to derive a calculation result from which the mail class is determined may be adopted. Since the mail head shall comply with the SMTP protocol, therefore in determination of the mail class, the fields to be determined all have been preset, thereby resulting in rapid determination of the mail class. Further, since the behavior model is established from the mail head, the behavior model can be useful in determination regardless of a specific language of the mail body.

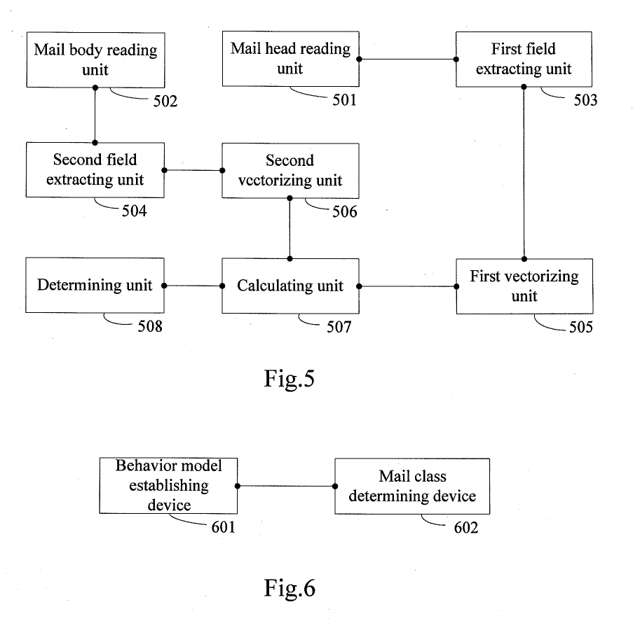

FIG. 5 illustrates another embodiment of a device for determining a mail class. The device for determining a mail class includes a mail head reading unit 501, a mail body reading unit 502, a first field extracting unit 503, a second field extracting unit 504, a first vectorizing unit 505, a second vectorizing unit 506, a calculating unit 507, and a determining unit 508.

The mail head reading unit 501 is adapted to read a mail head of a mail with an unknown class. The mail body reading unit 502 is adapted to read a mail body of the mail with an unknown class. The first field extracting unit 503 is adapted to extract a first field in compliance with a first preset condition from the mail head. The second field extracting unit 504 is adapted to extract a second field in compliance with a second preset condition from the mail body. The first vectorizing unit 505 is adapted to vectorize the first field into a first preset number of first feature vectors. The second vectorizing unit 506 is adapted to vectorize the second field into a second preset number of second feature vectors. The calculating unit 507 is adapted to take the first feature vectors and the second feature vectors as input to a preset predictive algorithm for calculation with use of data stored for a behavior model to derive a calculation result. The determining unit 508 is adapted to determine the mail class of the mail with an unknown class from the calculation result of the calculating unit 507.

In one embodiment, the mail body of the mail with an unknown class is processed additionally, so that more accurate determination of the mail class may be made comprehensively from the contents of the mail head and the mail body.

FIG. 6 illustrates a system for determining a mail class. The system may include a behavior model establishing device 601, and a mail class determining device 602.

The behavior model establishing device 601 is adapted to establish a behavior model for determination of a mail class by a preset learning algorithm in a way that a mail head of a mail with a known class is read, a field in compliance with a preset condition is extracted from the mail head of the mail with a known class, the field is vectorized into a preset number of feature vectors, or any combination thereof.

The mail class determining device 602 is adapted to read a mail head of a mail with an unknown class, to extract a field in compliance with the preset condition from the mail head of the mail with an unknown class, to vectorize the field into the preset number of feature vectors, to take the feature vectors as input to a preset predictive algorithm for calculation with use of data stored for the behavior model to derive a calculation result, to determine the mail class from the calculation result, or any combination thereof.

The functional units in the behavior model establishing device and the mail class determining device for extracting the mail head, for extracting the field, and for vectorization can be shared, may reduce the cost of the system for determining a mail class.

This embodiment of the system for determining a mail class can take advantage of the mail head of the mail with a known class to establish the behavior model and use the behavior model for determination of the mail class of the mail with an unknown class. Since the specific field in the mail head is vectorized while the mail head shall comply with the SMTP protocol, therefore in determination of the mail class, the fields to be determined all have been preset, thereby resulting in rapid determination of the mail class. Further, since the behavior model is established from the mail head, the behavior model can be useful in determination regardless of a specific language of the mail body.

The method, device and system for determining a mail class and the device for establishing a behavior model according to the embodiments of the invention have been described in details above, and the above descriptions of the embodiments are provided only to facilitate understanding of the method according to the invention. It will be appreciated for those ordinarily skilled in the art that modifications are possible in specific implementations and applications of the invention without departing from the invention. Accordingly, the specification shall not be taken in any way of limiting the scope of the invention as defined in the appended claims.

What is claimed is:

1. A method for determining a mail class, comprising:
reading a mail head of a mail with an unknown class;
extracting a first field in compliance with a first preset condition from the mail head;
vectorizing combinations of the first field and first field presentation forms into a first preset number of first feature vectors;
calculating a calculation result using a preset predictive algorithm, preset predictive algorithm having the first feature vectors and data stored for a behavior model as inputs; and
determining the mail class of the mail with the unknown class from the calculation result.

2. The method for determining a mail class according to claim 1, further comprising:
reading a mail body of the mail with an unknown class;
extracting a second field in compliance with a second preset condition from the mail body;
vectorizing combinations of the second field and its presentation forms into a second preset number of second feature vectors; and
inputting the second feature vectors together with the first feature vectors as input to the preset predictive algorithm for calculation with use of the data stored for the behavior model to derive the calculation result.

3. The method for determining a mail class according to claim 1, wherein the behavior model is established by:
reading a mail head of a mail with a known class;
extracting a third field in compliance with a third preset condition from the mail head of the mail with a known class;
vectorizing combinations of the third field into a third preset number of third feature vectors; and
establishing the behavior model for the third feature vectors in a preset learning algorithm.

4. The method for determining a mail class according to claim 3, wherein the third field is the same as the first field.

5. The method for determining a mail class according to claim 1, wherein the first field comprises the From field, the To field, the Reply-To field, the Delivered-To field, the Return-Path field, the Received field, the Date field, or any combination thereof.

6. The method for determining a mail class according to claim 2, wherein the first field comprises the From field, the To field, the Reply-To field, the Delivered-To field, the Return-Path field, the Received field, the Date field, or any combination thereof.

7. The method for determining a mail class according to claim 3, wherein the first field comprises the From field, the To field, the Reply-To field, the Delivered-To field, the Return-Path field, the Received field, the Date field, or any combination thereof.

8. The method for determining a mail class according to claim 4, wherein the first field comprises the From field, the To field, the Reply-To field, the Delivered-To field, the Return-Path field, the Received field, the Date field, or any combination thereof.

9. The method for determining a mail class according to claim 3, wherein the third number is the same as the first number.

10. The method for determining a mail class according to claim 4, wherein the third number is the same as the first number.

11. A device for determining a mail class, comprising:
a mail head reading unit operable to read a mail head of a mail with an unknown class;
a first field extracting unit operable to extract a first field in compliance with a first preset condition from the mail head;
a first vectorizing unit operable to vectorize the first field into a first preset number of first feature vectors;
a calculating unit operable to take the first feature vectors as input to a preset predictive algorithm for calculation with use of data stored for a pre-established behavior model to derive a calculation result; and
a determining unit operable to determine the mail class of the mail with an unknown class from the calculation result.

12. The device for determining a mail class according to claim 11, further comprising:
a mail body reading unit operable to read a mail body of the mail with an unknown class;
a second field extracting unit operable to extract a second field in compliance with a second preset condition from the mail body; and
a second vectorizing unit operable to vectorize the second field into a second preset number of second feature vectors;
wherein the calculating unit is operable to take the first feature vectors and the second feature vectors as input to the preset predictive algorithm for calculation with use of the data stored for the behavior model to derive a calculation result.

13. A system for determining a mail class, comprising:
a behavior model establishing device operable to establish a behavior model for determination of a mail class by a preset learning algorithm in a way that a mail head of a mail with a known class is read, the behavior model establishing device being operable to extract a field in compliance with a preset condition from the mail head of the mail with a known class, and the field is vectorized into a preset number of feature vectors; and
a mail class determining device operable to read a mail head of a mail with an unknown class, to extract a field in compliance with the preset condition from the mail head of the mail with an unknown class, the mail class determining device being operable to vectorize the field into the preset number of feature vectors, to take the feature vectors as input to a preset predictive algorithm for calculation with use of data stored for the behavior model to derive a calculation result, and to determine the mail class from the calculation result.

14. A computer readable medium comprising code for:
reading a mail head of a mail with an unknown class;
extracting a first field in compliance with a first preset condition from the mail head;
vectorizing combinations of the first field and its presentation forms into a first preset number of first feature vectors;
calculating a calculation result using a preset predictive algorithm for calculation, the calculation being based on first feature vectors and data stored for a pre-established behavior model; and
determining the mail class of the mail with an unknown class from the calculation result.

15. A computer readable medium comprising code for:
establishing a behavior model for determination of a mail class by a preset learning algorithm in a way that a mail head of a mail with a known class is read,
extracting a field in compliance with a preset condition from the mail head of the mail with a known class, and the field is vectorized into a preset number of feature vectors;
reading a mail head of a mail with an unknown class;
extracting a first field in compliance with a first preset condition from the mail head;
vectorizing combinations of the first field and first field presentation forms into a first preset number of first feature vectors;
calculating a calculation result using a a preset predictive algorithm for calculation, the calculation being based on the first feature vectors and data stored for a pre-established behavior model; and
determining the mail class of the mail with an unknown class from the calculation result.
